(19) United States
(12) Patent Application Publication
(10) Pub. No.: US 2016/0075170 A1
(43) Pub. Date: Mar. 17, 2016

(54) SELF-ADHESIVE SURFACE COVERING

(71) Applicant: TEMPAINT, LLC, Woodinville, WA (US)

(72) Inventors: Lane Kleppen, Seattle, WA (US); Travis Rager, Mill Creek, WA (US)

(73) Assignee: TEMPAINT, LLC, Woodinville, WA (US)

(21) Appl. No.: 14/728,893

(22) Filed: Jun. 2, 2015

Related U.S. Application Data
(60) Provisional application No. 62/049,635, filed on Sep. 12, 2014.

(51) Int. Cl. B43L 1/00; B32B 37/12

(52) U.S. Cl. CPC B43L 1/00; B32B 37/12

(57) ABSTRACT

A removable surface covering comprising a base material layer having a first surface and a second surface, the first surface having a colored ink applied thereon, a transparent vinyl layer having an outer surface and an inner surface, the inner surface applied onto the first surface of the base material layer, the outer surface having an ultraviolet coating applied thereon, a release layer capable of having one or more shapes and patterns printed thereon for cutting and/or trimming, the paper being at least one of a wax-paper, a non-stick paper and a release-paper, and a pressure-sensitive adhesive disposed between the second surface of the base material layer and the release layer, the adhesive being a water-based acrylic.

### CROSS-REFERENCE TO RELATED APPLICATION

This application claims the benefit of priority to U.S. Provisional Application No. 62/089,239, entitled “Temporary Self-Adhesive Dry Erase Surface Covering” filed Dec. 9, 2014, the entire contents of which are incorporated herein by reference.

### FIELD

The present disclosure relates generally to the field of surface coverings, and in particular but not exclusively, relates to a dry-erase surface covering for the enhancement of walls, living spaces and work spaces.

### BACKGROUND

Current dry-erase products are generally limited to dry-erase boards and dry-erase capable paints. While useful in their own right, each of these products has limited utility and a unique set of problems that greatly limit the ways in which they can be used. Products with dry-erase surfaces generally come in specific pre-defined sizes or shapes, such as markerboards or pre-cut dry-erase flexible surfaces, which tend to limit where they can be used. These types of products are often difficult to install and frequently require mounting hardware. Also, such products are generally permanent in nature, cannot be easily removed from surfaces, and require extra effort to return the surfaces on which they are mounted to their original state.

Dry-erase boards are generally restricted to use on highly constrained, immovable surfaces, such as on walls or on easels. Although products do exist that purport to enable the mounting of dry-erase boards on moving surfaces such as on the doors of refrigerators or on doors (e.g., front doors, garage doors, etc.), they have numerous drawbacks including inconsistent mounting, poor mounting, and a general tendency to flop and bang around when such doors are in use. Thus, current conventional solutions can only be mounted in a few fixed locations and do not readily adhere to entire surfaces.

On the other hand, dry-erase capable paints present their own unique challenges. Often, dry-erase capable paints require the same level of work as is involved in applying regular paints when applying them to surfaces. As with regular paints, dry-erase capable paints usually require the same level of attention to taping, masking, fumes, dry times and clean-up times. And, more importantly, such dry-erase capable paints cannot be applied and removed for short periods of time for impromptu or ad hoc applications.

Thus, there is a significant and growing need for a dry-erase surface covering solution that can be applied to surfaces of differing sizes and that can be easily removed in a peel-and-stick fashion, repositioned and re-applied in a straightforward manner. There is also a need for a solution that reduces or eliminates the effort involved in the application of conventional dry-erase capable paints while ensuring a continued ability to quickly apply and remove dry-erase surfaces for short periods of time. And, there is a further need for a solution that will enable a dry-erase surface to adhere to movable surfaces without the drawbacks associated with the use of dry-erase boards on such surfaces.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 is a side view of a surface covering in an embodiment.

FIG. 2 is a perspective view of a surface covering in an embodiment.

FIG. 3 is a flow chart illustrating a method for making a surface covering in an embodiment.

### DETAILED DESCRIPTION

In the description to follow, various embodiments will be described, and specific configurations will be set forth. Numerous and specific details are given to provide an understanding of these embodiments. The aspects disclosed herein can be practiced without one or more of the specific details, or with other methods, components, or systems. In other instances, structures or operations are not shown or described in detail to avoid obscuring relevant inventive aspects.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification do not necessarily refer to the same embodiment. Furthermore, the particular features, structures, or characteristics may be combined in any suitable manner in one or more embodiments.

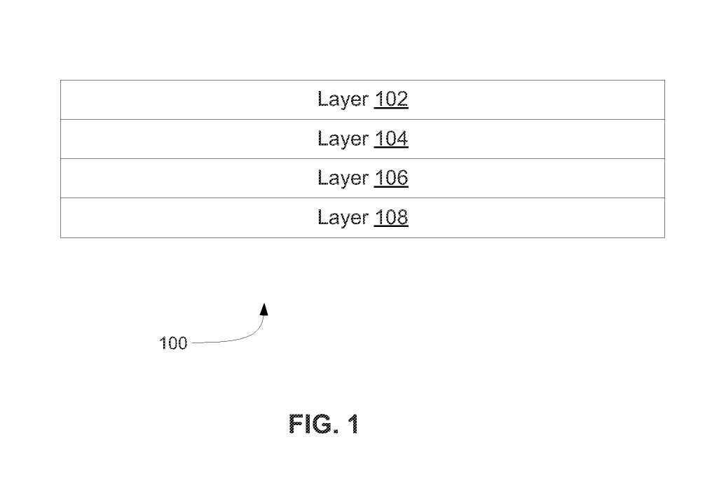

FIG. 1 is an illustration of the cross-sectional structure of a surface covering 100 in an embodiment. In the illustrated embodiment, the surface covering 100 is comprised of several layers. A transparent vinyl layer 102 is shown on the upper most level of the surface covering 100 which, in an embodiment, is comprised of polyvinyl chloride (PVC) with an ultraviolet coating on its outer surface. The use of ultraviolet coatings on materials imparts a “dry erase” property to them and enables them to be used with dry-erase markers in a variety of consumer and commercial environments. In alternative embodiments, the ultraviolet coating applied onto the transparent vinyl layer 102 is comprised of polyethylene, calcium carbonate or kaolinite. Use of such ultraviolet coatings provides for a surface covering 100 that is clear in appearance with a strong waterproof property. Beneath the transparent vinyl layer 102 is a base material layer 104 that is comprised of a vinyl material, a plastic material, a paper material or a cloth material in varying embodiments. The base material layer 104 is provided in alternative embodiments in either a dark color (e.g., black) or a light color (e.g., white, beige, tan, aqua blue, etc.). In the preferred embodiment, the base material layer 104 has a colored ink applied to its upper surface based on the preference of a manufacturer, a distributor, or a customer. The base material layer 104 in the preferred embodiment is greater than 0.08 millimeters in thickness and preferably about 0.12 millimeters in thickness. When combined, the finished thickness of the surface covering 100 is nominally 0.15 millimeters plus applicable manufacturing variances or tolerances that are generally in the range of +/−0.03 millimeters.

The transparent vinyl layer 102 is applied onto the upper surface of the base material layer 104 using a lamination process in an embodiment. Although a lamination process is preferred, different processes for binding the transparent vinyl layer 102 to the base material layer 104 can be used in alternative embodiments. A pressure sensitive adhesive is applied to a lower surface of the base material layer 104. This pressure sensitive adhesive forms an adhesive layer 106 that is disposed between the lower surface of the base material 104 and a release paper layer 108. The release paper layer 108 can include one or more shapes and patterns which are printed on this layer for use in cutting or trimming various structures, patterns or shapes as desired by an end user. The release paper layer 108 in alternative embodiments is comprised of wax paper, nonstick paper or release paper. In different embodiments, alternative forms of release materials can be used provided the unique adhesive quality of the pressure-sensitive adhesive used in the adhesive layer 106 is preserved. In one specific embodiment, the adhesive layer 106 is comprised of a water based acrylic having a thickness range in a preferred embodiment from 0.02 millimeters to 0.04 millimeters. This preferred thickness range for the adhesive layer 106 ensures that it will not lose its adhesive property over an extended period of time (e.g., between one to five years) while also enabling the surface covering 100 to be removed or repositioned with the removal of little to none of the underlying paint on the surface to which the surface covering 100 has been applied.

The adhesive layer 106 is applied such that the thickness is sufficient to achieve a desired degree of adhesion to a surface (e.g., a wall or an object surface) without causing the removal of the underlying paint on a wall or surface. For lighter colored hues, the base material layer 104 is comprised of a light or white base material. For darker colored hues such as black, dark blue or dark red, the base material is in a preferred embodiment black in color. The use of a white base material or a black base material onto which colored ink is applied prevents the visual appearance of overlapping regions after application of a surface covering. Specifically, when using a white base material in the base material layer 104 with lighter colored ink applied to the upper surface of the base material layer 104, any overlapping of surface covering material that occurs will not produce visually darker hues (i.e., distinctly darker lines which visibly mark the end of one section of material when laid upon a different section of material) in an overlapped region. This optical property is used to preserve the appearance of consistency in overlapping regions and to avoid the appearance of darker lines or zones when they overlap as is common in conventional surface coverings. In addition, the use of a transparent vinyl layer 102 prevents the run-off onto the hands of users of the colored ink which is applied to the base material layer 104 while also providing added protection from mechanical wear and fading or degradation due to sustained exposure to ultraviolet rays.

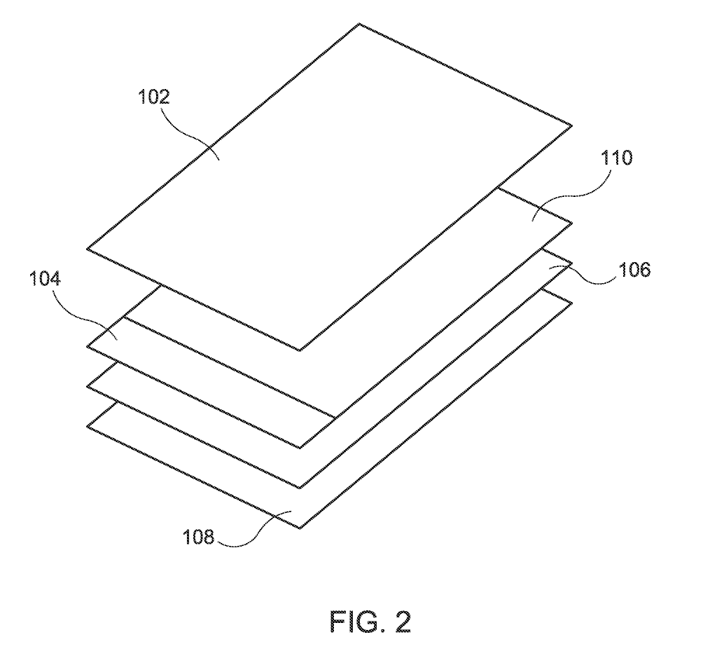

FIG. 2 is a perspective view of each layer in the surface covering 100 in an embodiment. In the illustrated embodiment, the transparent vinyl layer 102 is shown applied onto an upper surface of the base material layer 104 on which a colored ink has been applied 110. The transparent vinyl layer 102 is provided primarily to protect the surface covering 100 from mechanical wear and fading or degradation due to sustained exposure to ultraviolet rays. A variety of colored inks can be applied to the base material layer 104 to achieve a desired finish. As discussed above, for black, dark red, dark blue or darker hues, a black base material is used for the base material layer 104. For lighter colors, a white colored base material 104 is used. The base material layer 104 is shown applied onto a release paper layer 108 with use of a pressure sensitive adhesive. This pressure sensitive adhesive is applied as an adhesive layer 106 that is disposed between the lower face of the base material layer 104 and the upper surface of the release paper layer 108.

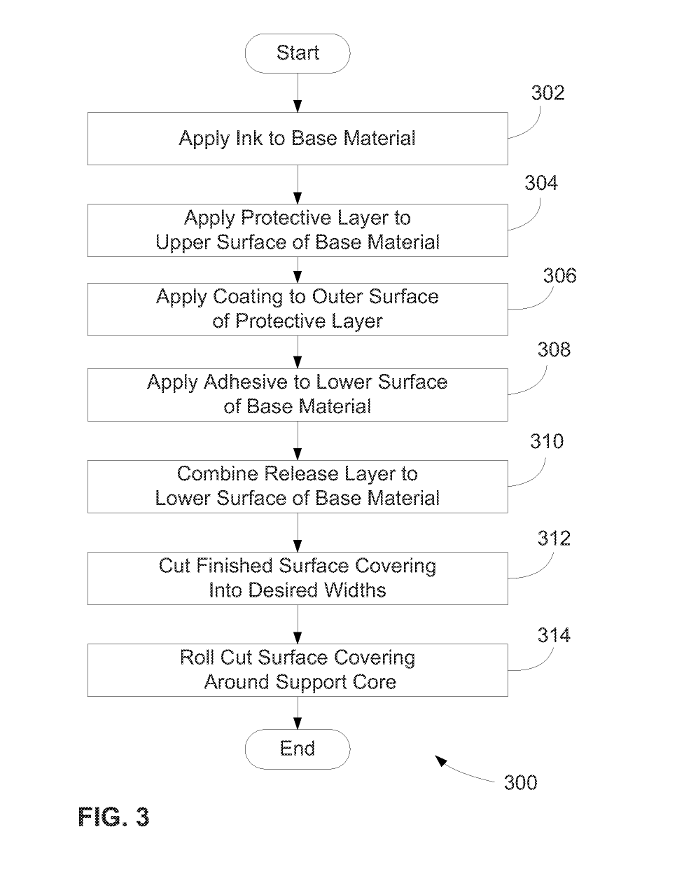

FIG. 3 is a flowchart illustrating a process 300 for making a surface covering with a dry erase surface in an embodiment. In this illustrated embodiment, a colored ink is applied to a base material, as shown at step 302. The colored ink is applied to an upper surface of the base material without leaking or the addition of colored ink to a lower surface of the base material. After application of the ink to the base material, a protective layer of transparent vinyl material is applied to the upper surface of the base material, as shown at step 304, to protect the surface covering against mechanical wear and fading or degradation due to exposure to ultraviolet rays. In one embodiment, the protective layer is applied to the upper surface of the base material using a lamination process. As will be appreciated by those of ordinary skill in the art, other conventional processes can be used to apply a protective vinyl layer onto a base material layer of the type described herein. After application of the protective layer and creation of an interim sub-assembly, an ultraviolet coating is applied to the outer surface of the protective layer to achieve a desired dry-erase property on a surface covering, as shown at step 306.

After application of the ultraviolet coating to the protective layer, an adhesive layer is applied to the lower surface of the base material, as shown at step 308. A release paper is then combined to the lower surface of the base material layer using the adhesive layer, as shown at step 310, to produce a finished covering. The release paper includes in alternative embodiments various forms of printed material including text and photos such as measuring grids, application instructions, application photos, and shapes or patterns for cutting and trimming (e.g., butterflies, stars, or diamonds). The finished covering is then cut into desired widths (e.g., an American Standard roll of wallpaper, a 6-inch strip for applying wall borders, etc.), as shown at step 312, which can then be rolled onto a support core, as shown step 314, for convenient packaging and shipment.

In applying the surface covering, a user peels away a 2 to 6 inch segment of the release paper. The surface covering is then aligned and the exposed adhesive portion is placed in contact with an application surface (e.g., a wall or ceiling). The release paper is removed a small portion at a time by peeling it away from the adhesive layer and afterwards the user applies consistent pressure to the surface covering on the application surface using methodical sweeping motions across its surface to reduce or eliminate air trapped between the application surface and the surface covering. Once a portion of an application surface has been covered, added portions of the surface covering can be provided alongside or slightly overlapping the initial portion of the surface covering. After coverage of the desired portions or areas of an application surface, the user can use a cutting edge (e.g., a utility knife or a pair of scissors, etc.) to trim any excess portions of the surface covering from select areas (e.g., unintentionally covered areas, etc.). When no longer needed or desired, the user can then remove the surface covering from an application surface by slowly peeling away a corner of the surface covering and then gently pulling back and alongside the entirety of the surface covering.

Although specific embodiments have been illustrated and described herein, it will be appreciated by those of ordinary skill in the art that a wide variety of alternate and/or equivalent implementations may be substituted for the specific embodiments shown and described without departing from the scope of the present disclosure. This application is intended to cover any adaptations or variations of the embodiments discussed herein.

What is claimed is:

1. A removable surface covering comprising:
a base material layer having a first surface and a second surface, the first surface having a colored ink applied thereon;
a transparent vinyl layer having an outer surface and an inner surface, the inner surface applied onto the first surface of the base material layer, the outer surface having an ultraviolet coating applied thereon;
a release layer having one or more shapes and patterns printed thereon for cutting and/or trimming, the paper being at least one of a wax-paper, a non-stick paper and a release-paper; and
a pressure-sensitive adhesive disposed between the second surface of the base material layer and the release layer, the adhesive being a water-based acrylic having a thickness range from 0.02 mm to 0.04 mm.

2. The removable surface covering of claim 1 wherein the release layer is comprised of material having descriptive content, the descriptive content being at least one of a measuring grid, textual application instructions and application photos.

3. The removable surface covering of claim 1 wherein the base material layer is comprised of at least one of a vinyl material, a plastic material, a paper material and a cloth material.

4. The removable surface covering of claim 1 wherein the transparent vinyl layer is comprised of polyvinyl chloride.

5. The removable surface covering of claim 1 wherein the ultraviolet coating comprises at least one of a polyethylene coating, a calcium carbonate coating and a kaolinite coating.

6. The removable surface covering of claim 1 wherein the base material layer has a thickness that is greater than 0.08 mm.

7. The removable surface covering of claim 1 wherein the base material layer has a thickness of approximately 0.12 mm.

8. The removable surface covering of claim 1 having a thickness of approximately 0.15 mm plus manufacturing variances of +/−0.03 mm.

9. The removable surface covering of claim 1 wherein the base material layer is comprised of a white-colored material when the applied colored ink is a lighter colored ink.

10. The removable surface covering of claim 1 wherein the base material layer is comprised of a black-colored material when the applied colored ink is a darker colored ink.

11. The removable surface covering of claim 10 wherein the darker colored ink is at least one of a dark red color and a dark blue color.

12. A method of making a removable surface covering, the method comprising:
applying a colored ink to a first surface of a base material;
laminating a transparent vinyl layer onto the first surface of the base material to produce an interim sub-assembly;
applying an ultraviolet coating onto an outer surface of the laminated transparent vinyl layer of the interim sub-assembly; and
applying a pressure-sensitive adhesive layer between a second surface of the base material in the interim sub-assembly and a release layer, the release layer having one or more shapes and patterns printed thereon for cutting and/or trimming, the paper being at least one of a wax-paper, a non-stick paper and a release-paper.

13. The method of claim 12 wherein the applying of the pressure-sensitive adhesive layer includes applying a water-based acrylic having a thickness range from 0.02 mm to 0.04 mm.

14. The method of claim 12 wherein the applying of the ultraviolet coating comprises applying at least one of a polyethylene coating, a calcium carbonate coating and a kaolinite coating.

15. The method of claim 12 wherein the applying of the colored ink includes applying a lighter colored ink when the base material is white in color.

16. The method of claim 12 wherein the applying of the colored ink includes applying a darker colored ink when the base material is black in color, the darker colored ink being at least one of a dark red color and a dark blue color.
